(19) United States
(12) Patent Application Publication
(10) Pub. No.: US 2024/0242627 A1
(43) Pub. Date: Jul. 18, 2024

(54) MODULAR NASOPHARYNGEAL AIRWAY INSERTION TRAINING ADJNUCT AND SYSTEM

(71) Applicant: MOCHTECH, LLC, Grover, MO (US)

(72) Inventors: Robb Mourton, Grover, MO (US); Wesley Mourton, Ballwin, MO (US)

(73) Assignee: MOCHTECH, LLC, Grover, MO (US)

(21) Appl. No.: 18/412,746

(22) Filed: Jan. 15, 2024

Related U.S. Application Data
(60) Provisional application No. 63/439,722, filed on Jan. 18, 2023.

(51) Int. Cl. G09B 23/28

(52) U.S. Cl. CPC G09B 23/285

(57) ABSTRACT

A modular Nasopharyngeal Airway Insertion training adjunct for a medical training device having an orifice that opens into an inner cavity. The adjunct includes a base that releasably attaches to the medical training device, and a simulated nasal anterior aspect affixed to the base. Two nasal orifices extend into an inner chamber of the aspect. The inner chamber opens into an orifice in the base. The base orifice aligns with the medical training device orifice when the base is properly attached to the medical training device, so as to enable Nasopharyngeal Airway Insertion training there through.

### CROSS REFERENCE TO RELATED APPLICATIONS

This application derives and claims priority from U.S. provisional application 63/439,722, filed Jan. 18, 2023, and having Attorney Docket No. MOCH H013US, which provisional application is incorporated herein by reference.

### STATEMENT REGARDING FEDERALLY SPONSORED RESEARCH OR DEVELOPMENT

Not Applicable.

### FIELD

The present teachings generally relate to medical training devices, and more particularly to a modular nasopharyngeal airway insertion training apparatus and associated components.

### BACKGROUND

The statements in this section merely provide background information related to the present disclosure and may not constitute prior art.

Learning the proper skill and precision for safely and effectively performing a Nasopharyngeal Airway Insertion (aka “NPA”) procedure on a patient, particularly an NPA that is to be performed in emergency situations, can be a difficult and onerous process. Such training becomes more complex and complicated when the training must occur at home or under field conditions, i.e., at locations other than established medical training facilities such as for example at temporary and/or mobile military medical facilities or bases.

Medical personnel whose job responsibilities include performing NPA procedures on patients must be trained and often certified for that skill set. That skill set also requires regular practice to maintain proficiency and recertification. In addition, in emergency situations or in military battlefield circumstances, a timely and proper NPA procedure can mean the difference between life and death for an injured patient. That is, proper and effective NPA training can prepare a medical responder to timely and properly treat a leading cause of preventable death in a traumatic emergency—i.e., upper airway obstruction in the nose, nasopharynx or base of the tongue. Consequently, in addition to benefiting medical personnel in performing routine NPA procedures, ongoing training and practice of proper NPA procedure techniques by emergency responders and military troops is therefore critically important.

Traditional NPA training devices are designed for classroom settings. Such devices typically include a replicated human body part (e.g., a head and neck, or torso), and focus on anatomical correctness—not convenience. Most require support components (e.g., pumps and monitors) that link to the anatomical component with tubes and wires. Traditional NPA trainers are therefore bulky and cumbersome, not very durable or very portable, and not well-suited for home use or for field training conditions. Up until recently, the prevailing attitude in the medical community had been that the student would learn and practice NPA techniques at an institution or facility supplied with a traditional training device. As a consequence, training, certification and recertification efforts have been traditionally focused on classroom training, with few options for home or other out-of-classroom practice.

Moreover, traditional NPA training components are almost uniformly “stand alone.” That is, they are produced as an individual training device to be used only for NPA training, and cannot be used for other purposes or in conjunction with other medical training devices. Unfortunately, individuals learning NPA procedures will typically also have a need for training in other medical treatment techniques, such as for example, various medical needle insertions techniques. Traditional NPA trainers are not designed for such cross-training purposes.

Recently, a few “portable” or “personal” medical training devices have been introduced, including for example the self-contained needle insertion training systems disclosed in U.S. Pat. Nos. 8,556,634, 8,808,005, 10,380,918 and 10943507 (collectively, the “MITS™ Patents”). Such training systems are stand-alone devices that are designed to either augment or to be used in conjunction with traditional classroom training programs. However, the devices covered by the MITS™ Patents have not been capable of providing Cricothyrotomy training.

It therefore would be desirable to have an improved NPA training device that can be used in a traditional classroom setting or as a portable or take-home trainer that can be used in conjunction with classroom training or a classroom trainer, and/or can be used in conjunction with a needle insertion training system, such as for example, one or more of the devices covered by the MITS™ Patents.

### BRIEF DESCRIPTION OF SEVERAL VIEWS OF THE DRAWINGS

The illustrative embodiments of the present invention are shown in the following drawings which form a part of the specification. The drawings described herein are for illustration purposes only and are not intended to limit the scope of the present teachings in any way.

FIG. 1 is a perspective view of a representative first embodiment of an NPA training adjunct, in accordance with the present disclosure.

FIG. 2 is a top view of the NPA training adjunct of FIG. 1.

FIG. 3 is side elevation view of the NPA training adjunct of FIG. 1.

FIG. 4 is an alternate perspective view of the NPA training adjunct of FIG. 1.

FIG. 5 is a second alternate perspective view of the NPA training adjunct of FIG. 1.

FIG. 6 is a third alternate perspective view of the NPA training adjunct of FIG. 1.

FIG. 7 is a perspective view of the body of a representative MITS™ medical needle training device without endcaps.

FIG. 8 is a side view of the NPA training adjunct of FIG. 1 being attached to the representative MITS™ body of FIG. 7 with end caps attached, and showing a representative NPA tube alongside the MITS™ body.

FIG. 9 is a side view of the NPA training adjunct and representative MITS™ body of FIG. 7, showing a user inserting a representative NPA tube into and through the one of two nasal orifices of the adjunct and into the interior of the MITS™ body.

FIG. 10 is a perspective view of the NPA training adjunct of FIG. 1 isolated from the MITS™ body, with a representative NPA tube inserted into one of the nasal orifices of the adjunct.

Corresponding reference numerals indicate corresponding parts throughout the several views of drawings.

### DETAILED DESCRIPTION

The following description is merely representative in nature and is not intended to limit the present disclosure or the disclosure's applications or uses. Before turning to the figures and the various representative embodiments illustrated therein, a detailed overview of various embodiments and aspects is provided for purposes of breadth of scope, context, clarity, and completeness.

Further areas of applicability of the present teachings will become apparent from the description provided herein. It should be understood that the description and specific examples are intended for purposes of illustration only and are not intended to limit the scope of the present teachings.

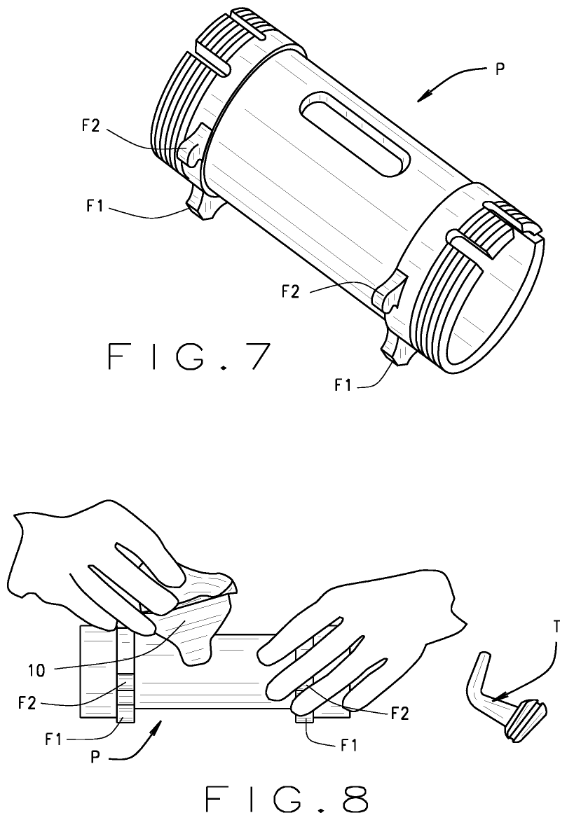

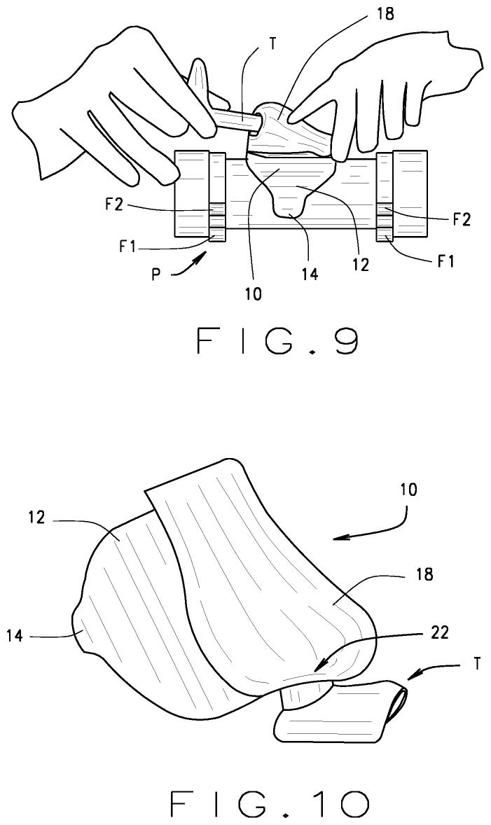

As described and disclosed herein are improvements to embodiments of a modular NPA training adjunct 10 for a medical training device, such as for example the self-contained needle insertion training platform as disclosed, for example, in U.S. Pat. No. 10,943,507 (hereinafter, the “MITS™ Platform”), which disclosure is incorporated by reference herein. A representative MITS™ Platform P without its endcaps is depicted in FIG. 7, and the adjunct 10 is shown attached to and in use on a representative MITS™ Platform P in FIGS. 8-9. Generally, a self-contained needle insertion training device such as for example the MITS™ Platform P, provides expedient and precise skills training for various medical needle insertion techniques, including for example, intravenous (“IV”), intramuscular, subcutaneous and needle decompression. In various embodiments, the MITS™ Platform P includes a rigid hollow body having at least one sidewall with a training region having a training port or orifice O (see FIG. 7), with the sidewall defining an inner cavity. The body is cylindrical and approximately two to three inches in diameter and approximately six inches long, and has at least one set of feet F1 and F2 positioned near the end caps as shown in FIG. 7. In this embodiment, the feet F2 are configured with a slight downward hook.

It is envisioned that the MITS™ Platform P can be used, for example, in the field by military forces to instruct critical combat lifesaving skills to soldiers and host nation forces, as well as providing an excellent commercial training tool for personal use as well as in the classroom setting, and may be used as a foundational component in conjunction with the modular system 10. In particular, the MITS™ Platform P can be sized to approximate the average size of the front portion of a human face, such that the Platform P can be securely held and stabilized with one hand of the user, leaving the user's other hand free to practice NPA training techniques described herein.

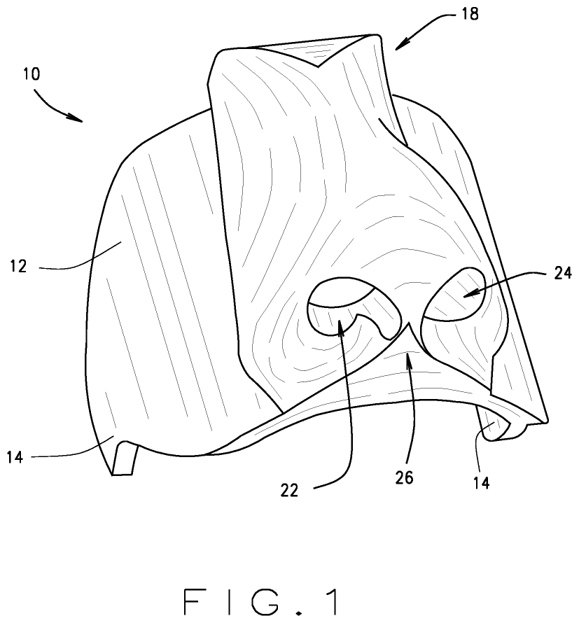

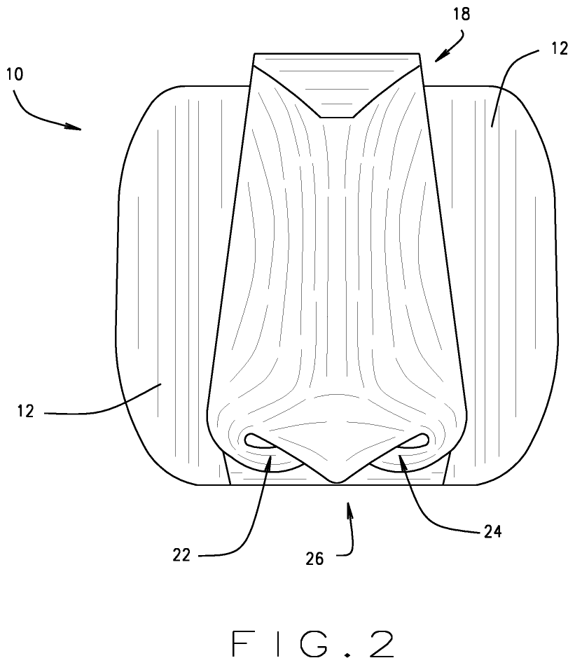

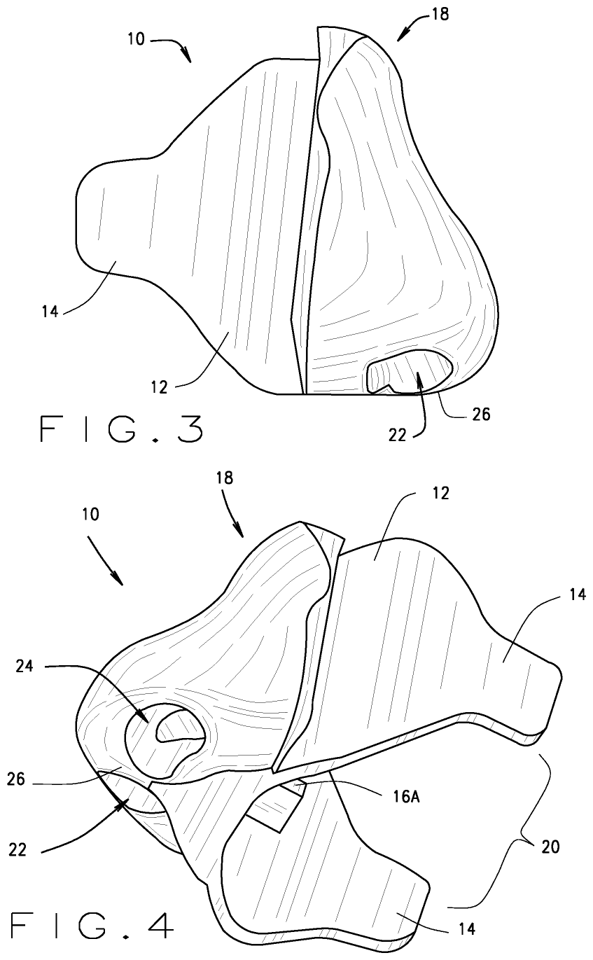

Referring now to FIGS. 1-6, the present disclosure provides a modular NPA training adjunct 10 that comprises a base 12, two generally rectangular curved flanges 14 that extend from the base 12, a pair of flat and rectangular positioning or alignment structures or tabs 16A and 16B, and the anterior aspect of a simulated human nose or nasal anterior aspect 18. The modular adjunct 10 is formed from a substantially rigid, though somewhat elastic plastic, although other materials may be used. The base 12 is a semicircular shell that is approximately 0.125 inch thick, approximately 1.75 inches long, approximately 2.25 inches wide, and has a radius of curvature of approximately 1.0 inch. Each of the two flanges 14 extends downward from and longitudinally along one of the two sides of base 12. The flanges 14 are each approximately 0.625 inches long and 0.75 inches wide, and generally continue the curvature of the portion of the base 12 from which they extend, to collectively form an elastic clamp 20 there between (see FIGS. 4-6).

Positioning tab 16A is approximately 0.375 inches wide, 0.125 inches thick, and 0.30 inches tall. Positioning tab 16B is approximately 0.375 inches wide, 0.125 inches thick, and 0.125 inches tall along the side furthest from the center of the base 12. The height of the tab 16B tapers to 0.00 inches for the side closest to the center of the base 12. The positioning tabs 16A and 16B each extend in a perpendicular fashion downward from the underside of the base 12, are oriented parallel to one another, and each is positioned approximately 0.25 inches from its respective end of the base 12.

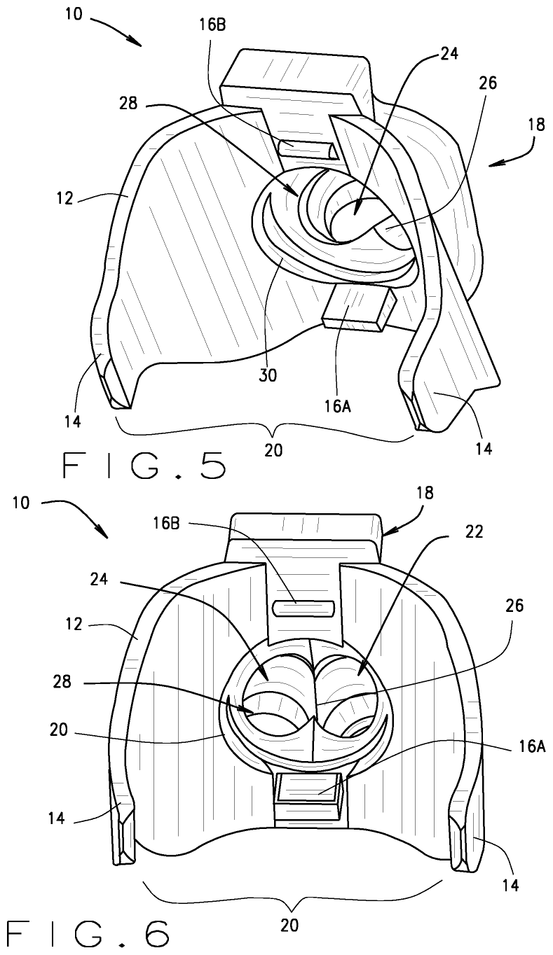

The nasal anterior aspect 18, which is generally the size and shape of a human nose, is formed on and rises upward from the upper surface of the base 12, and includes a first nostril or nasal orifice 22 and a second nostril or nasal orifice 24. The first nasal orifice 22 is separated from the second nasal orifice by an anterior nasal spine 26. The first nasal orifice 22 and the second nasal orifice 24 both open into an inner chamber 28 positioned directly behind the nasal spine 26 (see FIGS. 5, 6). The chamber 28 is somewhat tubular and generally circular in cross-section opposite the nasal spine 26, and extends from the nasal spine 26, through the body of the nasal anterior aspect 18, and opens opposite the nasal spine 26 into a one-inch diameter circular access orifice 30 in the center of the base 12 between the positional tabs 16A and 16B. The chamber 28 has a height of approximately 0.50 inches and a diameter of approximately 1.00 inches between the positional tabs 16A and 16B. The chamber 28 can be configured to mimic the nasal cavities behind the nostrils.

As can be seen and appreciated by one of ordinary skill in the art, and as depicted in FIGS. 8-9, this configuration of the modular adjunct 10 is designed to releasably clip onto a MITS™ Platform P. The tabs 16A and 16B are sized and shaped to fit in each end of the orifice O in the MITS™ Platform P in order to properly orient and align the adjunct 10 when clipped onto the top of the Platform P. As can also be appreciated, the orifice 30 is positioned and oriented on the base 12 so as to align with the needle insertion training orifice O of a MITS™ PlatformP(see FIG. 6) when the modular adjunct 10 is properly attached to the Platform. This positioning of the modular adjunct 10 on the MITS™ Platform P allows the use of various NPA tools, such as for example, a representative NPA tube T as shown in FIGS. 8-10, in association with the modular adjunct 10 to facilitate NPA training. Thus, the modular adjunct 10 acts as a component of, and utilizes the features of, the training device (such as, for example, the MITS™ Platform P) to which it releasably attaches.

Referring now to FIGS. 8-9, a typical use of the modular adjunct 10 with a representative MITS™ Platform P is depicted. FIG. 8 shows a user releasably attaching (i.e., clipping onto) the adjunct 10 to the Platform P. The adjunct 10 is shaped and sized such that the underside of the base 12 matches and generally fits flush against the cylindrical outer surface of the center of the body of the Platform P. Yet, the flanges 14 are curved slightly inward and the distance between the flanges 14 is slightly less than the outer diameter of the center of the Platform P. Consequently, due to the slightly elastic nature of the base 12, the clamp 20 (formed by the flanges 14) can releasably “snap” or “clip” the adjunct 10 into place onto the Platform P. Of course, the shape and dimensions of the adjunct 10 can be adjusted so as to conform to a particular medical training device, such that that adjunct 10 can releasably “snap” or “clip” onto the device while aligning the orifice 30 to an orifice in such a platform. Here, as previously described, and as can be appreciated by one of ordinary skill in the art, the adjunct 10 is configured to allow the orifice 30 to align with the orifice O in the Platform P. When the adjunct is properly attached in this manner to the Platform P, the nasal anterior aspect 18 rises upward from the upper surface of the base 12. FIG. 8 also depicts the representative NPA tube T resting beside the Platform P.

In FIG. 9, a user is seen holding the combined training device (i.e., adjunct 10 and Platform P) on a stable surface with one hand, while using another hand to insert the NPA tube T. As can be appreciated, the NPA tube T is inserted through one of the first or second nasal orifices 22, 24, though the chamber 28 in the modular adjunct 10, through the training orifice O of the MITS™ Platform P, and into the body of the Platform, for emergency NPA training. For illustration purposes, FIG. 10 shows the NPA tube T inserted into one of the first or second nasal orifices 22, 24 of the modular adjunct 10, where the adjunct 10 is separated from the Platform P. It should also be noted that the tab 16B is shorter than the tab 16A to minimize the potential for interference with the NPA tube as it is inserted into and through the adjunct 10.

While we have described in the detailed description several configurations that may be encompassed within the disclosed embodiments of this invention, numerous other alternative configurations, that would now be apparent to one of ordinary skill in the art, may be designed and constructed within the bounds of our invention as set forth in the claims. Moreover, the above-described novel mechanisms of the present invention, shown by way of example at 10 can be arranged in a number of other and related varieties of configurations without departing from or expanding beyond the scope of my invention as set forth in the claims. Thus, the description herein is merely exemplary in nature and variations that do not depart from the gist of that which is described are intended to be within the scope of the teachings. Such variations are not to be regarded as a departure from the spirit and scope of the teachings.

For example, the modular adjunct 10 can be configured to attach to alternate medical training devices, other than the MITS™ Platform P depicted and described in this disclosure, where such devices have an orifice that is sized and shaped to receive, for example, the representative NPA tube T, through the modular adjunct 10 when the modular adjunct 10 is attached to such a device. Of course, the adjunct 10 may be configured differently to enable mating with such an alternate medical training device, so long as the combination of the adjunct 10 and the device function as disclosed herein and enable NPA training on a medical training device as discussed herein.

In addition, adjunct 10 is not limited to having exactly two open nostrils, such as the first and second nasal orifices 22, 24. Rather, the adjunct 10 may, for example, be configured such that only one of the first and second nasal orifices 22, 24 is open. Similarly, the chamber 28 in the adjunct 10 need not have the exact configuration as disclosed. Rather, the chamber 28 may have different sizes and shapes, so long as it generally replicates the interior nasal passages of a human nose, and opens at one end to a nasal orifice and opens at the other end to the orifice 30, and is configured to enable NPA training on a medical training device as discussed herein.

Further, component 10 is not limited to having exactly one orifice such as the circular access orifice 30 in the base 12. Rather, the component 10 may be configured such that there is a full separation between the first nasal orifice 22 and the second nasal orifice 24, to thereby form two corresponding separate chambers instead of the single chamber 28, and two corresponding orifices in the base 12 in the vicinity of each of such separate chambers.

Also, the orifice 30 need not have the exact configuration shown, but may be any variety of shapes, so long as it properly mates with its corresponding orifice in the training device, such as for example the orifice O in the Platform P, to which the adjunct is attached, and allows for the passage of an NPA tube, such as for example the NPA tube T, through the orifice for NPA training.

Further, the outer shape of the nasal anterior aspect 18 is not limited to the shape depicted in the Figures. Rather, the nasal anterior aspect 18 may be of any variety of shapes and sizes, although preferably having the general shape of a human nose, and is configured to enable proper NPA training on a medical training device as discussed herein. Such configurations—whether more or less anatomically correct—can be employed to replicate these features of a human nose.

Similarly, the alignment tabs 16A and 16B can have varying shapes and sizes, so long as they provide proper alignment between the adjunct 10 and the medical training device to which the adjunct 10 attaches, as explained in this disclosure. Further, there may be fewer or more than exactly two tabs 16A and 16B, and the adjunct 10 can be configured without such tabs 16A and 16B.

Although the adjunct 10 preferably attaches to a training device (such as for example, the MITS™ Platform P) so as to align the orifice 30 with the training orifice O, the adjunct 10 may alternatively be configured such that the orifice 30 instead aligns with a different orifice in the training device that is not necessarily used for training purposes—so long as such a configuration allows proper NPA training on a medical training device as discussed herein.

While the MITS™ Platform P is depicted by preference as cylindrical, it is contemplated that the MITS™ Platform P, and other such training platforms, may be of a wide variety of other shapes and sizes. For example, the MITS™ Platform P may for example be box-shaped, oval, hexagonal or polygonal. In such circumstances, the modular adjunct 10 can be modified or adapted to releasably attach to any such variety or configuration of the MITS™ PlatformP(or other medical training device), so long as the adjunct 10 can be configured such that the orifice 30 aligns with a training orifice of medical training device in a position and manner that allows a user to practice NPA training on the device when so positioned.

Depending upon the shape and configuration of the training devices to which the modular adjunct 10 attaches, and the orientation of the orifices in such devices, the modular adjunct 10 may have differing contours and shapes and sizes to accommodate accurate positioning of the adjunct onto the trainer to properly correspond to and mate with such orifices in the trainer.

In addition, other components or features can be added to adjunct 10 to provide more anatomical accuracy. For example, the shape of the nasal anterior aspect 18 may be altered to reflect differences within the norm of human nasal features, or one or more cheek structures may be added next to the aspect 18.

Although the embodiments of the adjunct 10 disclosed and described contemplate the use of a substantially rigid yet slightly elastic polymer, other materials can be used instead—so long as the adjunct 10 is able to be secured to the medical training device, such as the MITS™ Platform P. For example, the adjunct 10 may include fully rigid materials, such as metals components, so long as it also includes portions that can attach to the medical training device in the manner described herein. Further, instead of having a flexible base 12 and attachment flanges 14, the adjunct 10 may include any of a variety of other types of fasteners or attachment devices such as for example, one or more of a clip, a clamp, a ratchet, a belt, a latch, a screw, a bolt, an elastic band, a hook, and a pin.

The descriptions herein are merely exemplary in nature and, thus, variations that do not depart from the gist of that which is described are intended to be within the scope of the teachings. Such variations are not to be regarded as a departure from the spirit and scope of the teachings.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the representative embodiments and implementations described above without departing from the scope of the disclosure. Accordingly, all matter contained in the above description or shown in the accompanying drawings should be interpreted as illustrative and not in a limiting sense.

It is further to be understood that any processes or steps described herein are not to be construed as necessarily requiring their performance in the particular order discussed or illustrated. It is also to be understood that additional or alternative processes or steps may be employed.

What is claimed is:

1. A modular Nasopharyngeal Airway Insertion training adjunct for a medical training device, said medical training device having a body with an inner cavity, said body having an orifice that opens into said cavity, said adjunct comprising:
a. a base, said base releasably attaching to said medical training device, said base having an access orifice there through, said access orifice aligning at least in part with said medical training device orifice when said base is attached to said medical training device; and
b. a simulated human nasal anterior aspect attached to said base, said simulated human nasal anterior aspect having a first nasal orifice positioned on said simulated nasal anterior aspect corresponding to one of a right nostril and a left nostril, said orifice extending through said simulated nasal anterior aspect and into said base access orifice.

2. The modular Nasopharyngeal Airway Insertion training adjunct of claim 1, further comprising an inner chamber, said inner chamber being positioned between said access orifice and said first nasal orifice, said inner chamber opening into one of said access orifice and said first nasal orifice.

3. The modular Nasopharyngeal Airway Insertion training adjunct of claim 1, wherein said nasal anterior aspect further has a second nasal orifice positioned on said simulated nasal anterior aspect, said second nasal orifice corresponding to the other of said right nostril and left nostril.

4. The modular Nasopharyngeal Airway Insertion training adjunct of claim 1, wherein said base further has a first alignment structure protruding from said base, said first alignment structure being shaped and sized to extend into said medical training device orifice when said adjunct is attached to said medical training device.

5. The modular Nasopharyngeal Airway Insertion training adjunct of claim 4, wherein said base further has a second alignment structure protruding from said base, said second alignment structure being shaped and sized to extend into said medical training device orifice, said first and second alignment structures being oriented to secure the proper position and orientation of said base on said medical training device.

6. The modular Nasopharyngeal Airway Insertion training adjunct of claim 1, further comprising a fastener, said fastener releasably attaching said base to said medical training device.

7. The modular Nasopharyngeal Airway Insertion training adjunct of claim 6, wherein said fastener comprises one of a clip, a clamp, a ratchet, a belt, a latch, a screw, a bolt, an elastic band, a hook, and a pin.

8. The modular Nasopharyngeal Airway Insertion training adjunct of Claim 1, wherein said base comprises an elastic flange, said elastic flange being positioned and oriented to apply pressure to said medical training device when said base is attached to said medical training device.

9. The modular Nasopharyngeal Airway Insertion training adjunct of claim 1, wherein said medical training device comprises a MITS™ Platform, said MITS™ Platform having a needle insertion training orifice.

10. The modular Nasopharyngeal Airway Insertion training adjunct of claim 9, wherein said first orifice aligns at least in part with said needle insertion training orifice when said base is attached to said MITS™ Platform.

11. A modular Nasopharyngeal Airway Insertion training system, said system comprising:
a. a medical training device, said device having a body with an inner cavity, said body having an orifice, said orifice opening into said inner cavity;
b. a simulated human nasal adjunct, said adjunct having a base with a simulated nasal anterior aspect formed thereon, said anterior aspect having a first nasal orifice corresponding to one of a right nostril and a left nostril, said nasal orifice extending through said nasal anterior aspect and through said base, said nasal orifice shaped and sized to enable the insertion of a Nasopharyngeal Airway tube there through; and
C. a fastener, said fastener releasably attaching said adjunct to said medical training device such that said nasal orifice aligns at least in part with said medical training device orifice in an orientation to allow said Nasopharyngeal Airway tube to extend through said adjunct when said adjunct is attached to said medial training device.

12. The modular Nasopharyngeal Airway Insertion training system of claim 11, wherein said nasal anterior aspect further has a second nasal orifice positioned on said simulated nasal anterior aspect, said second nasal orifice corresponding to the other of said right nostril and left nostril.

13. The modular Nasopharyngeal Airway Insertion training system of claim 11, wherein said fastener comprises one of comprises one of a clip, a clamp, a ratchet, a belt, a latch, a screw, a bolt, an elastic band, a hook, and a pin.

14. The modular Nasopharyngeal Airway Insertion training system of claim 11, wherein said fastener extends from said base and comprises an elastic flange, said elastic flange being positioned and oriented to apply pressure to said medical training device when said base is attached to said medical training device.

15. The modular Nasopharyngeal Airway Insertion training adjunct of claim 11, wherein said medical training device comprises a MITS™ Platform, said MITS™ Platform having a needle insertion training orifice.

16. The modular Nasopharyngeal Airway Insertion training adjunct of claim 15, wherein said first orifice aligns at least in part with said needle insertion training orifice when said base is attached to said MITS™ Platform.

17. The modular Nasopharyngeal Airway Insertion training system of claim 11, wherein said base further has a first alignment structure protruding from said base, said first alignment structure being shaped and sized to extend into said medical training device orifice when said adjunct is attached to said medical training device.

18. The modular Nasopharyngeal Airway Insertion training system of claim 17, wherein said base further has a second alignment structure protruding from said base, said second alignment structure being shaped and sized to extend into said medical training device orifice, said first and second alignment structures being oriented to secure the proper position and orientation of said base on said medical training device.

19. The modular Nasopharyngeal Airway Insertion training system of claim 11, wherein said adjunct further comprises an inner chamber, said inner chamber being positioned between said access orifice and said first nasal orifice, said inner chamber opening into one of said access orifice and said first nasal orifice.
